(19) United States
(12) Patent Application Publication
(10) Pub. No.: US 2011/0105835 A1
(43) Pub. Date: May 5, 2011

(54) METHOD FOR PRESERVING SPERM AND APPLICATIONS THEREOF

(76) Inventors: Michele Magistrini, Saint-avertin (FR); Elodie Pillet, Chamousset (FR); Florence Batellier, Tours (FR); Guy Duchamp, Sonzay (FR)

(21) Appl. No.: 12/809,962

(22) PCT Filed: Dec. 24, 2008
(86) PCT No.: PCT/FR08/01822

§ 371 Date: Sep. 15, 2010

(30) Foreign Application Priority Data
Dec. 27, 2007 (FR) FR 07/09145

(51) Int. Cl. A61D 19/02; A01N 1/02

(52) U.S. Cl. 600/35; 435/1.1; 435/1.3

(57) ABSTRACT

The invention relates to a sperm dilution medium that comprises a base medium to which are added yolk or yolk plasma, glycerol and native phosphocaseinate. The medium can particularly be used for the freeze-preservation of mammal sperm in order to enhance the fertilization capability of the frozen sperm.

### CROSS-REFERENCE TO RELATED APPLICATIONS

This application is a U.S. National Stage of international application PCT/FR2008/001822, filed Dec. 24, 2008, which designates the U.S., and is not filed in English, and claims priority from French patent application FR 07/09145, filed Dec. 27, 2007. Each of these applications is incorporated by reference herein in its entirety.

### BACKGROUND OF THE INVENTION

This invention concerns the field of sperm preservation and more specifically the preservation of the fertilizing capability of spermatozoa weakened by freezing or another treatment.

With the development of reproduction biotechnologies, artificial insemination techniques are commonly used in numerous animal species, including the caprine, ovine, porcine, bovine and equine species. However, spermatozoa are complex and highly specialized cells that can quickly lose their fertilizing power. Thus, the long-term preservation of cooled (positive temperatures) or frozen sperm while maintaining its fertilizing power presents a problem.

Thus, in order to allow optimum preservation of sperm until it is used for artificial insemination, a medium in which the sperm is diluted as soon as it is collected is usually used. The sperm/dilution medium mixture is then divided into aliquots containing a sufficient number of spermatozoa to fertilize the ovum, for example at least 2·10⁸ spermatozoa in horses for artificial insemination with “fresh” semen. Depending on the dilution medium used and the temperature at which the sperm/medium mixture is stored, preservation time will generally vary from a few hours to several days, or even a longer period in cases where the medium allows for freezing. Sperm preserved at between 4 and 20° C. has the disadvantage of having to be used within hours or within 2-3 days following collection. Conversely, preserving sperm by freezing makes it possible to store the semen of a male for several years. Freezing the sperm also makes it possible to preserve the genetic heritage pool of a male of high genetic value and to potentially continue its blood line after its death or its castration. Freezing sperm also makes it possible to transport sperm to breeding farms that are geographically distant from the collection site, which facilitates genetic exchange and distribution or the international sale of semen.

However, it has been demonstrated that the freezing/thawing process reduced the percentage of intact spermatozoa (Watson, P. F., Anim. Reprod. Sci. 60-61: 481-492, 2000): freezing has the disadvantage of causing the deterioration of important physiological functions of the spermatozoa, partially or completely reducing their fertilizing power. Since the quality of the semen is crucial during artificial insemination, an insemination dose containing a large number of dead or weakened spermatozoa will have reduced fertilizing power thus limiting the fertility of the male after insemination.

The development of a dilution medium making it possible to improve semen preservation and to preserve good fertilizing capability of the spermatozoa during freezing is thus the subject of numerous research projects.

In stallions, the medium used to carry out the first successful artificial insemination using frozen stallion sperm was composed of pasteurized whole milk containing 10% glycerol (Barker et al., Canadian Journal of Comparative Medical Veterinary Science, 21: 47-51, 1957).

Among the dilution media used most frequently for freezing stallion semen, we can cite in particular the media described by Martin et al. (J. Reprod. Fertil., Suppl. 27: 47-51, 1979), Burns, P. J. (Proc. 12^{th} International Congress on Animal Reproduction The Hague 1992; 4: 1849-1851), and the medium called “INRA82,” described by Palmer, E. (Proc. 10^{th} International Congress on Animal Reproduction and Artificial Insemination, Urbana-Champaign, Ill. USA, 3:377, 1984), amended by Magistrini et al. (Acta Veterinaria Scandinavica, 1^{st} European Symposium on Production, Evaluation and Preservation of Stallion Semen, Oct. 1-2, 1992, Uppsala, Sweden, Suppl. 88, 97-110) and composed of a base medium with added UHT skim milk.

Generally speaking, these freezing media are supplemented with various substances in order to improve the protection of the spermatozoa. Vidament et al. (Theriogenology, 54, 907-19, 2000) developed the technique described by Palmer, E. (1984): the sperm is diluted in the INRA82 medium supplemented with egg yolk and centrifuged, then the sperm pellet is placed in the same medium also supplemented with glycerol, prior to freezing. The best results are obtained by carrying out centrifugation and adding glycerol at a temperature of 22° C., then gradual cooling to 4° C. prior to filling the straws and freezing; under these conditions, we note not only an improvement in sperm motility after thawing, but also an improvement in fertility.

However, even under these optimized conditions, the fertilizing power of spermatozoa after thawing remains relatively weak. A study conducted in France over the 1985-2005 period at the French Haras Nationaux [National Stud Farms] reports that the pregnancy rate achieved following artificial insemination with stallion sperm frozen in the INRA82 medium mentioned above supplemented with egg yolk and glycerol under the conditions indicated earlier and using semen whose motility after thawing is greater than 35% was only 45-48% (Vidament, M., Anim. Reprod. Sci. 89: 115-136, 2005 compared to 55% for fresh semen.

Alongside sperm dilution media intended for freezing, there are also others intended for preserving spermatozoa at positive temperatures. Thus, PCT Application WO9837904 describes a sperm dilution medium composed of a base medium containing native phosphocaseinate and/or β-lactoglobulin as a replacement for the milk. At a temperature of 4° C., the dilution medium containing native phosphocaseinate performs similarly to, and even at times more poorly than the base medium INRA82 supplemented with UHT skim milk; conversely, it very significantly improves the sperm preservation at 15° C.

### SUMMARY OF THE INVENTION

The inventors tested the effects of a sperm dilution medium as described in PCT Application WO9837904, supplemented with egg yolk and glycerol, on the preservation of spermatozoa during freezing. Initial tests showed that this medium did not improve the motility parameters of the spermatozoa after thawing compared to a base medium supplemented with milk (the INRA82 medium mentioned earlier), egg yolk and glycerol. On the other hand, the inventors have now surprisingly established that it considerably improved the fertilizing power of the spermatozoa.

This improvement in fertilizing power appears to be linked to the ability of this medium to effectively preserve the integrity of the spermatozoa membrane during the stress resulting from freezing/thawing. It can therefore be used to improve the fertilizing power of sperm weakened not only by freezing but by any other handling likely to have a deleterious effect on the membranes of the spermatozoa. This is the case for flow cytometry used in certain species of breeding animals to separate the Y spermatozoa from the X spermatozoa prior to insemination.

This invention concerns the use of a sperm dilution medium composed of:
a base medium comprising components suitable for diluting the sperm of a determined species;
native phosphocaseinate;
egg yolk; and
glycerol;
to improve the fertilizing capability of spermatozoa weakened or damaged by freezing and/or by flow cytometric sperm sorting.

### BRIEF DESCRIPTION OF THE DRAWINGS

FIG. 1 is a histogram showing the results obtained as described in Example 2 for the MV, PROG and RAP parameters comparing the INRA82+EY+G medium and the INRA96®+EY+G medium.

FIG. 2 is a histogram presenting the results obtained as described in Example 2 for the MV, PROG and RAP motility parameters comparing the INRA96+G medium and the INRA96®+EY+G medium.

FIG. 3 is a diagram that represents the results obtained as described in Example 2 during resistance testing of the membrane of the spermatozoa. The pressures tested are indicated on the x-axis and the percentage of spermatozoa having incorporated the PI is indicated on the y-axis. The curve with diamonds presents the results obtained after freezing in the INRA82+EY+G medium, the curve with squares those obtained after freezing in the INRA96®+EY+G medium.

FIG. 4 is a histogram assessing the fertilizing power of sperm after freezing as described in Example 3. The fertility per cycle is represented on the y-axis and the freezing media INRA82+EY+G and INRA96®+EY+G are indicated on the x-axis.

FIG. 5 is a histogram showing the results as described in Example 4a) obtained for the MV, PROG and RAP motility parameters performed with the semen of six adult Welsh stallions at the rate of two ejaculates per stallion. The white bars represent the results of each of the three parameters evaluated after freezing of the spermatozoa in the INRA96®+EY+G medium; the black bars represent the results of each of the three parameters evaluated after freezing of the spermatozoa in the INRA96®+EYplasma+G medium.

FIG. 6 contains two histograms A and B showing in vitro results as described in Example 4b) on ejaculates of two stallions, respectively, which were then used for an in vivo fertility test (see FIG. 7) at the rate of four ejaculates for stallion MW438 (A) and five ejaculates for stallion MW329 (B).

FIG. 7 is a histogram assessing the fertilizing power of sperm of two stallions MW438 and MW329 after freezing as described in Example 4B) for each of the INRA96®+EYplasma+G and INRA96®+EY+G media. The white bars represent the results obtained after freezing of the semen in the INRA96®+EYPlasma+G medium; the black bars represent the results obtained after freezing of the semen in the INRA96®+EY+G medium.

### DETAILED DESCRIPTION OF THE INVENTION

Egg yolk is composed of a fluid in which various particles are suspended (ANTON, Recent Res. Devel. in Agricultural & Food Chem., 2, 839-864, 1998). It is this fluid that is called: “egg yolk plasma.” These two phases can be easily separated by centrifugation. This separation is generally done by diluting the egg yolk (to reduce its viscosity) in water or a slightly saline solution (typically an NaCl solution with a molarity of less than 0.3 M and preferably less than 0.2M), and by subjecting the mixture thus obtained to centrifugation under conditions (e.g. 10,000 g for 30 minutes) making it possible to separate the plasma, which constitutes the supernate, from the “granules” fraction, which forms the pellet at the bottom of the centrifuge tube. Advantageously, it is possible, if desired, to carry out a second centrifugation in order to eliminate the granules fraction more completely.

Generally, the egg yolk plasma will also be sterilized via gamma irradiation, for example.

“Base medium comprising components suitable for diluting the sperm of a determined species” means any medium containing the chemically defined components usually used in the sperm dilution media used for this species. This generally involves a solution of mineral salts and glucides at an appropriate pH. The nature and the proportions of these different components may vary depending on the species concerned. This base medium may also include additives such as antibiotics or antifungal agents.

According to a preferred embodiment of this Invention, the sperm dilution medium used comprises:
from 1 to 10%, and preferably from 1.5 to 5% glycerol;
from 0.5 to 12.5%, preferably from 0.5 to 5%, and more preferably still, from 1 to 2.5% by weight of egg yolk dry matter or 0.4 to 10%, preferably 0.4 to 4% and more preferably still from 0.8 to 2% by weight of egg yolk plasma dry matter;
between 1 and 100 g/l and preferably between 10 and 50 g/l native phosphocaseinate.

The egg yolk is composed of around 50% dry matter, and the egg yolk plasma represents around 80% of the egg yolk dry matter: as a result, 2% fresh egg yolk provides around 1% by weight of egg yolk dry matter and around 0.8% by weight of egg yolk plasma dry matter.

This invention may be used in connection with artificial insemination in different species of mammals, particularly in the caprine, ovine, porcine, bovine and equine species and in a particularly advantageous manner in the bovine and equine species, in accordance with the usual artificial insemination methods for the species concerned, which are known on their own by the person skilled in the art.

This invention will be better understood by means of the additional description that follows, which refers to non-limiting examples of its use in horses.

### THE EXAMPLES

### Example 1

### Materials and Methods

### a) Sperm Dilution Media

The two sperm dilution media used in the comparative tests presented below are the “INRA82” and “INRA96®” media.” The “INRA82” medium is a mixture of 0.5 liter of a base medium (saline-glucose solution: glucose 25 g·L⁻¹, lactose 1.5 g·L⁻¹, raffinose 1.5 g·L⁻¹, dehydrated sodium citrate 0.25 g·L⁻¹, potassium citrate 0.41 g·L⁻¹, hepes buffer 4.76 g·L⁻¹) with 0.5 liter of milk at pH 6.8. The “INRA96®” medium is described in PCT Application WO9837904, as well as in the publication by Batellier et al., 1997 Theriogenology, 48-3, 391-410): it is composed of a base medium (HGGL medium, composed of Hank's salts supplemented with hepes buffer, lactose and glucose) and 27 g/L of native phosphocaseinate.

The two media also contain 50,000 IU·L⁻¹ of penicillin and 50 mg·L⁻¹ of gentamicin.

The INRA82 and INRA96® media were also supplemented with 2% centrifuged egg yolk (at 600×g for 10 minutes to eliminate possible contamination by egg white, the chalaza or shell debris) and 2.5% glycerol: these media will be called INRA82+EY+G and INRA96®+EY+G respectively in the remainder of this document.

For comparison purposes, the INRA96® medium supplemented only with 2.5% glycerol was also tested. This medium is hereinafter called INRA96®+G.

### b) Sperm Collection and Preparation

Three adult Welsh stallions of known fertility were used for this study. They were housed in the experimental unit of the Institut National de la Recherche Agronomique [National Institute for Agronomic Research] (INRA) in Nouzilly, France. Seven ejaculates per stallion were treated. Following collection, the semen was filtered on gauze in order to remove the “gel” fraction coming from the seminal vesicles. Immediately after filtration, each ejaculate was divided into two aliquots that were diluted in the INRA82 and INA96® media, the minimum dilution being 1 volume of semen per 3 volumes of medium. The mixture was then cooled to 22° C. for 10 minutes, then centrifuged at 600 g for 10 minutes. The pellet was then resuspended either in the INRA82+EY+G medium or in the INRA96®+EY+G medium, depending on the type of medium used for the first step, in order to obtain a final concentration of 100·10⁶ spermatozoa per ml. Each sample was cooled to 4° C. for 75 minutes and loaded into frozen polyvinyl chloride straws sealed with a polymerizing powder. Freezing was done using a programmable freezer to lower the temperature by 60° per minute until the temperature of −140° C. was reached. The straws were then stored in liquid nitrogen at −196° C., then thawed in a water bath for 30 seconds at 37° C. immediately before the analyses or the artificial inseminations

### Example 2

### In Vitro Evaluation of the Quality of the Sperm after Freezing

The motility of the spermatozoa and the resistance of their plasma membrane to a range of hypoosmotic pressures were analyzed via automated computer-assisted motility analysis or by fluorimetry.

### a) Motility of the Spermatozoa

To evaluate the motility of the spermatozoa, three straws of each of the 7 ejaculates and for each of the 3 stallions were thawed then diluted in a concentration of 20·10⁶ spermatozoa per ml in each of the INRA 82 or INRA96® media. Prior to analysis, the diluted sperm samples were incubated for 10 minutes at 37° C. The three following motility parameters of the spermatozoa were evaluated using an automated motility analyzer (IVOS, Version 10, Hamilton Thorne, Beverly, Mass., USA): the mean velocity (MV) in μm·s⁻¹, the percentage of progressive spermatozoa (PROG) and the percentage of rapid spermatozoa (RAP: spermatozoa having a mean velocity greater than 30 μm·s⁻¹). The analyses were performed on 2 drops per sample and per straw and 3 optical fields per drop)

### Comparison Between the INRA82+EY+G Medium and the INRA96®+EY+G Medium.

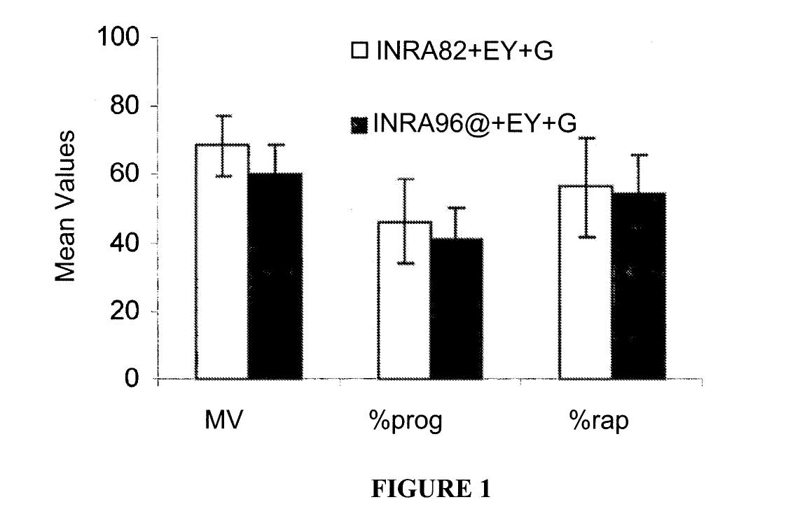

FIG. 1 is a histogram showing the results obtained for the MV, PROG and RAP parameters. The white bars represent the results of each of the three parameters evaluated after freezing of the spermatozoa in the INRA82+EY+G medium and the dark gray bars represent the results of each of the three parameters evaluated after freezing of the spermatozoa in the IRA96®+EY+G medium. The error bars correspond to the standard deviation.

These results show that the mean velocity, the percentage of progressive spermatozoa and the percentage of rapid spermatozoa are significantly higher when the semen is frozen in the INRA82+EY+G medium versus the INRA96®+EY+G medium (MV: 82 μm·s⁻¹ versus 66 μm·s⁻¹, p<0.0001; PROG: 51% versus 45%, p<0.0001, RAP: 61% versus 58%, p<0.01). It is clear from this analysis that during freezing under these experimental conditions, the INRA82+EY+G medium preserves the motility of the spermatozoa better than the INRA96®+EY+G medium.

### Comparison Between the INRA96+G Medium and the INRA96®+EY+G Medium.

To compare the INRA96+G medium and the INRA96®+EY+G medium, 10 ejaculates coming from 5 stallions, at the rate of 2 ejaculates per stallion, were collected, frozen and thawed under the same conditions as those described above.

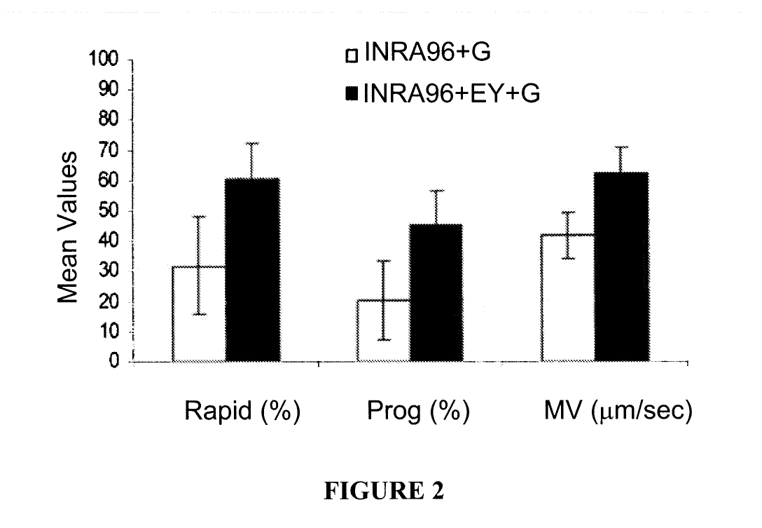

FIG. 2 is a histogram presenting the results obtained for the MV, PROG and RAP motility parameters. The white bars represent the results of the parameters evaluated after freezing of the spermatozoa in the INRA96+G medium, the black bars represent the results of the parameters evaluated after freezing of the spermatozoa in the INRA96®+EY+G medium. The error bars correspond to the standard deviation.

These results clearly show that the mean velocity (MV), the percentage of progressive spermatozoa (PROF) and the percentage of rapid spermatozoa (RAPID) are significantly higher if the semen is frozen in the INRA96®+EY+G medium compared to the INRA96®+G medium (MV: 63 μm·s⁻¹ versus 42 μm·s⁻¹, p<0.001; PROG: 45.5% versus 20%, p<0.001, RAP: 60% versus 32%, p<0.001). These results thus show that during freezing, the INRA96 medium must be supplemented jointly with glycerol and egg yolk in order to best preserve the motility of the spermatozoa.

### b) Integrity of the Plasma Membrane

The evaluation of the membrane of the spermatozoa was performed using the method described in the caprine species by Leboeuf et al. (Animal Reproduction Science, 91, 3-4: 265-274, 2006) and in the equine species by Defoin et al. (Anim. Reprod. Sci. 89: 219-223, 2005). This consists in testing the resistance of the membrane of the spermatozoa subjected to a hypoosmotic stress. The semen is thawed (two straws per ejaculate and five ejaculates per stallion) and diluted in each of the INRA82 or INRA96® media at the concentration of 20·10⁶ spermatozoa per ml. The diluted spermatozoa were immediately centrifuged at 500 g for 4 minutes, then the pellet resuspended in Hank's saline solutions (Hank's salts solution), supplemented with 20 mM hepes with decreasing osmotic pressure (303, 205, 154, 103, 63, 35, 12 mOsm), was incubated for 15 minutes at 37° C. The spermatozoa were then diluted to 1·10⁶ spermatozoa per ml, stained with propidium iodide (PI, final concentration 2.5 ug·mL⁻¹), then incubated again for 5 minutes at 37° C. before the flow cytometry analysis (MoFlo® cell sorter, Darko society, Denmark) of the incorporation of the IP by the spermatozoa.

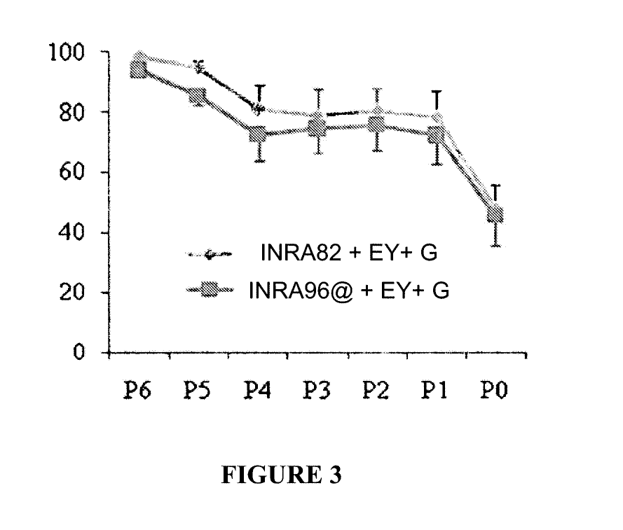

FIG. 3 is a diagram that represents the results obtained during resistance testing of the membrane of the spermatozoa. The pressures tested are indicated on the x-axis: P0, P1, P2, P3, P4, P5 and P6 correspond respectively to the osmotic pressures 303, 205, 154, 103, 63, 35, 12 mOsm. The percentage of spermatozoa having incorporated the PI is indicated on the y-axis. The curve with diamonds presents the results obtained after freezing in the INRA82+EY+G medium, the curve with squares those obtained after freezing in the INRA96®+EY+G medium. The error bars correspond to the standard deviation.

FIG. 3 shows that during hypotonic osmotic stress, regardless of the osmotic pressure tested (205, 154, 103, 63, 35, 12 mOsm), the percentage of spermatozoa having incorporated the PI, which corresponds to the percentage of spermatozoa having a damaged membrane, is significantly lower (p<0.05) when the semen is frozen in the INRA82+EY+G medium. Conversely, in the medium at 303 mOsm (isoosmotic for the spermatozoa), PI incorporation is identical for the spermatozoa frozen in the INRA82+EY+G medium and those frozen in the INRA96®+EY+G medium. Additionally, whatever the medium used, the percentage of spermatozoa that incorporated the PI (therefore the percentage of spermatozoa having a damaged membrane) increases sharply in the hypoosmotic medium at 205 mOsm compared to the medium at 303 mOsm. These results thus indicate that the INRA96®+EY+G medium preserves the integrity of the membranes of the spermatozoa better during freezing.

### Example 3

### In Vivo Evaluation of the Fertilizing Power of the Sperm after Freezing

The fillies were given an ultrasound each day beginning on the first day of heat until ovulation. When a dominant follicle reached 35 mm, ovulation was induced by intravenous injection of 15 mg of C.E.G. (crude equine pituitary gonadotrophin; Duchamp et al., Journal of Reproduction and Fertility, 35: 221-228, 1987) (Day D0), then the fillies were inseminated the following day (D1) with 400·10⁶ spermatozoa previously frozen in either the INRA96®+EY+G medium of the INRA82+EY+G medium (inseminated volume: 4 ml, or 8 thawed, consolidated straws). The fillies were randomly divided into two lots. The 7 ejaculates used during the artificial inseminations had more than 35% rapid spermatozoa when thawed. This value is the minimum required for an ejaculate to be used in artificial insemination at the French Haras Nationaux.

The pregnancy diagnosis was performed by ultrasound on the 14^{th} post-ovulation day: the fertility rate per cycle was calculated as being the number of cycles leading to pregnancy compared to the total number of inseminated cycles.

Eighty-four filly cycles were used in all: 42 cycles with spermatozoa previously frozen in the INRA96®+EY+G medium and 42 cycles with spermatozoa previously frozen in the INRA82+EY+G medium.

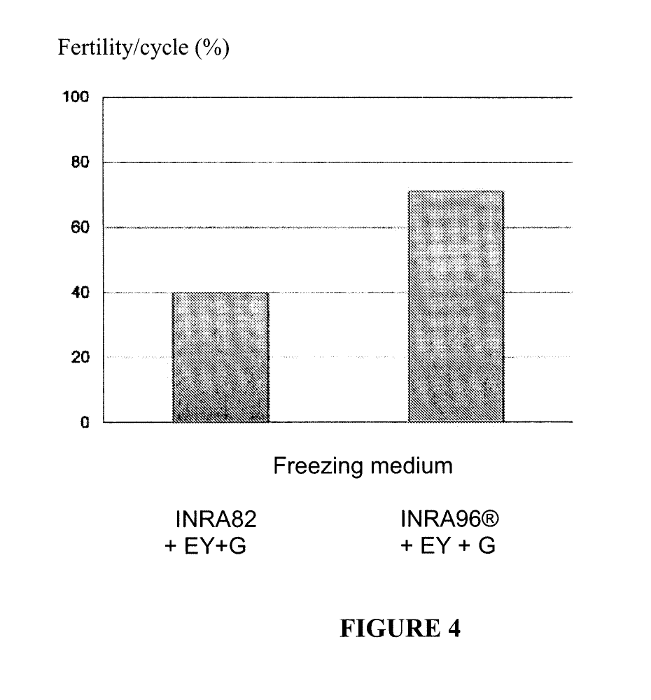

The results are presented in the histogram in FIG. 4. The fertility per cycle is represented on the y-axis and the freezing media INRA82+EY+G and INRA96®+EY+G are indicated on the x-axis.

These results show that the fertility per cycle obtained after artificial insemination with spermatozoa frozen in the INRA96®+EY+G medium is 71% (30 pregnancies for 42 inseminations) while that obtained with the spermatozoa frozen in the INRA82+EY+G medium is only 40% (17 pregnancies for 42 inseminations).

In conclusion, the INRA96® medium supplemented with 2% centrifuged egg yolk and 2.5% glycerol significantly improves (p<0.01) the fertilizing capability of frozen spermatozoa compared to the control medium INRA82+EY+G.

### Example 4

### Use of Egg Yolk Plasma in the INRA96+G Medium as a Replacement for Whole Egg Yolk

The egg yolk plasma was prepared by volume to volume dilution of whole egg yolk in 0.17M NaCl followed by centrifugation at 10,000×g for 45 minutes. The supernate of this centrifugation was recovered and centrifuged again at 10,000×g for 45 minutes. The supernate of this 2^{nd} centrifugation is the egg yolk plasma that was used for the rest of the experiments. Prior to use, this plasma was sterilized via gamma ray irradiation (at 5 kGy). This plasma was used at a rate of 4% by volume (or around 1% dry matter) to supplement the INRA96® dilution medium.

The INRA96® with 4% egg yolk plasma and 2.5% glycerol is called INRA96®+EYplasma+G.

Comparative tests were conducted with the INRA96®+EYplasma+G and INRA96®+EY+G media.

The semen sample collection and preparation protocols are identical to those described in Example 1 above.

a) In Vitro Evaluation of the Quality of the Sperm after Freezing

The evaluation of the MV, PROG and RAP spermatozoa motility parameters was performed by automated analysis as described in example 2.
A first in vitro study was performed with the semen of six adult Welsh stallions at the rate of two ejaculates per stallion.

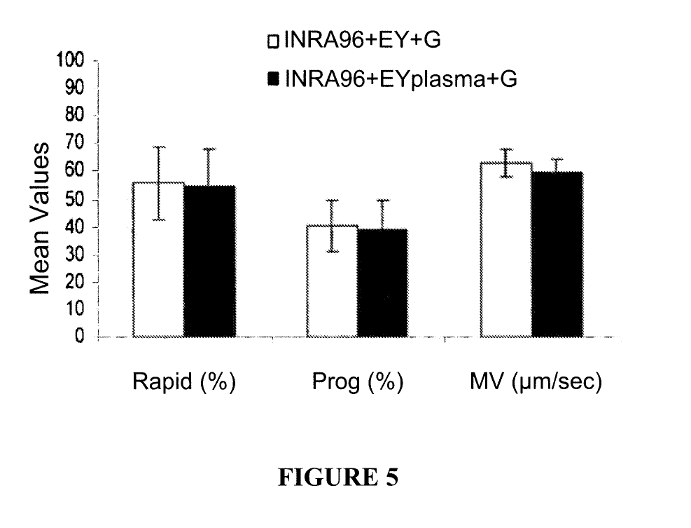

FIG. 5 is a histogram showing the results obtained for the MV, PROG and RAP motility parameters. The white bars represent the results of each of the three parameters evaluated after freezing of the spermatozoa in the INRA96®+EY+G medium; the black bars represent the results of each of the three parameters evaluated after freezing of the spermatozoa in the INRA96®+EYplasma+G medium. The error bars correspond to the standard deviation.

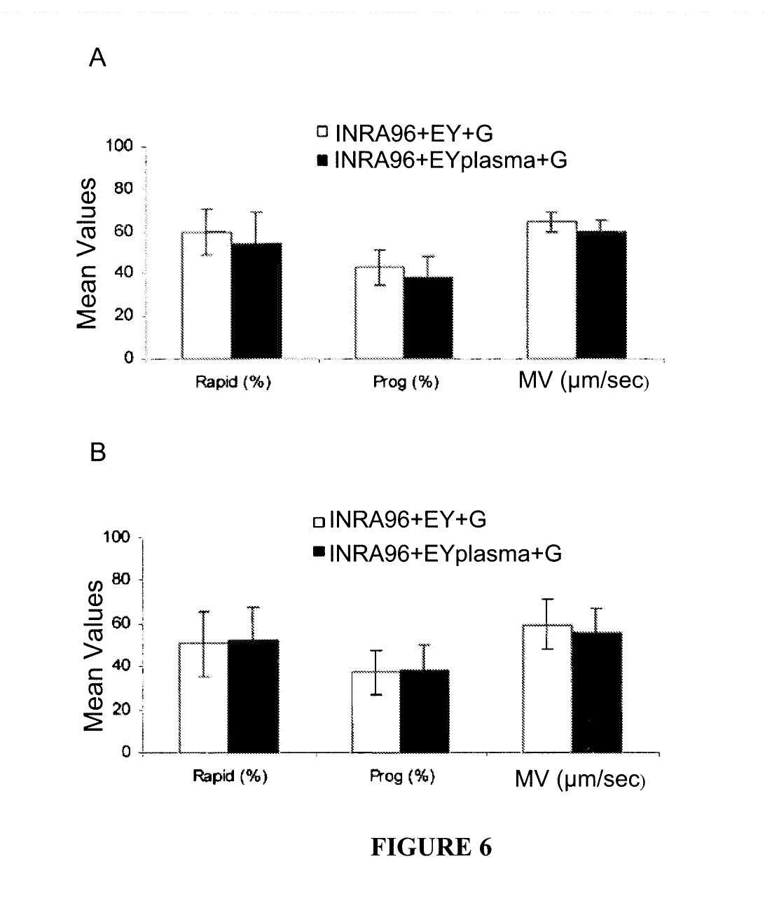

These results show that the mean velocity (MV) is significantly higher when the semen is frozen in the INRA96+EY+G medium compared to the INRA96+EYplasma+G medium (58 μmsec⁻¹ vs. 55.5 μmsec⁻¹; (p<0.05); conversely, no difference was revealed between the 2 media for the percentage of rapid spermatozoa (Rapid) and percentage of progressive spermatozoa (Prog) parameters (44% vs. 44% and 31% vs. 30%, respectively; p>0.05).
A second in vitro study was performed on the ejaculates of two stallions, which were then used for an in vivo fertility test (cf. below), at the rate of four ejaculates for stallion MW438 and five ejaculates for stallion MW329. The results of the automated analysis obtained for stallion MW438 are presented in FIG. 6.A; those obtained for stallion M329 are presented in FIG. 6.B.

These results show a slight increase in the mean velocity of the spermatozoa after freezing in the INRA96+EY+G medium. Conversely, there is no difference between the 2 media for the “percentage of rapid spermatozoa” and “percentage of progressive spermatozoa” parameters. These results are therefore comparable to the results obtained in the first study.

B) In Vivo Evaluation of the Fertilizing Power of the Sperm after Freezing

The evaluation of the fertilizing capability of spermatozoa of stallions MW438 and MW329 after freezing in the INRA96+EYplasma+G or INRA96+EY+G media was performed as described in example 3.

Seventy filly cycles were used in all in this study: 35 cycles with spermatozoa previously frozen in the INRA96®+EYplasma+G medium and 35 cycles with spermatozoa previously frozen in the INRA96®+EY+G medium. The fertility of the semen of stallions MW438 and MW329 was determined respectively over 19 and 16 cycles, for each of the INRA96®+EYplasma+G and INRA96®+EY+G media.

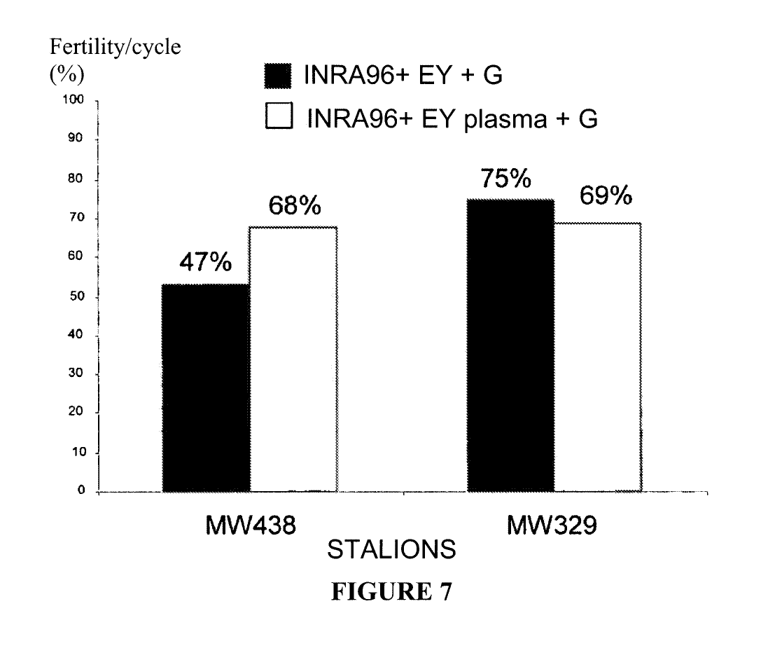

The results are presented in the histogram of FIG. 7. The fertility per cycle is represented on the y-axis and the stallions are indicated on the x-axis. The white bars represent the results obtained after freezing of the semen in the INRA96®+EYPlasma+G medium; the black bars represent the results obtained after freezing of the semen in the INRA96®+EY+G medium. The error bars correspond to the standard deviation.

These results show that the fertility per cycle obtained after artificial insemination with spermatozoa coming from stallion MW438 and from stallion MW329 frozen in the INRA96®+EYplasma+G is respectively 68% and 69% (13 pregnancies for 19 inseminations for MW438 and 11 pregnancies for 16 inseminations for MW329). The fertility per cycle after freezing in the INRA96®+EY+G medium is 47% (9 pregnancies for 19 inseminations) in the case of stallion MW438 and 75% (12 pregnancies for 16 inseminations) for stallion MW329.

These results show that spermatozoa frozen in the INRA96®+EYplasma+G medium preserve a high level of fertility after freezing, comparable to that observed after freezing with the INRA96®+EY+G medium.

In conclusion, these in vitro and in vivo results show that whole egg yolk may be replaced in the medium according to the invention with irradiated egg yolk plasma without affecting the quality of the spermatozoa and in particular their fertilization capability.

1.-5. (canceled)

6. A method for improving the fertilizing capability of sperm of a determined species which comprises the step of:
diluting the sperm in a sperm dilution medium comprising:
a base medium comprising components suited to diluting sperm of the given species;
native phosphocaseinate;
egg yolk or egg yolk plasma; and
glycerol.

7. The method of claim 6 wherein sperm is diluted in the sperm dilution medium on collection.

8. The method of claim 6 wherein the sperm is frozen after dilution.

9. The method of claim 6 wherein the sperm is subjected to flow cytometric sperm sorting after dilution.

10. The method of claim 6 wherein the sperm dilution medium comprises between 1 and 100 g/l native phosphocaseinate.

11. The method of claim 6 wherein the sperm dilution medium comprises between 10 and 50 g/l native phosphocaseinate.

12. The method of claim 11 wherein the sperm dilution medium comprises from 0.5 to 5% by weight egg yolk dry matter or from 0.4 to 4% by weight of egg yolk plasma dry matter and from 1 to 10% glycerol.

13. The method of claim 12 wherein the sperm dilution medium comprises from 1 to 2.5% egg yolk or from 0.8 to 2% by weight egg yolk plasma of dry matter and from 2 to 5% glycerol.

14. The method of claim 6 wherein the sperm is mammalian sperm.

15. The method of claim 14 wherein the sperm is sperm of the caprine, ovine, porcine, bovine or equine species.

16. The method of claim 14 wherein the sperm is sperm of the bovine or equine species.

17. The method of claim 6 wherein the sperm dilution medium consists of
a base medium comprising components suited to diluting sperm of the determined species;
native phosphocaseinate;
egg yolk or egg yolk plasma; and
glycerol.

18. A method of artificial insemination of a mammal of the caprine, ovine, porcine, bovine or equine species comprising the step of employing sperm of said species diluted in a sperm dilution medium by the method of claim 6 for artificial insemination.

19. The method of claim 18 wherein the diluted sperm is frozen after dilution or is subjected to flow cytometric sperm sorting after dilution.

20. The method of claim 18 wherein the mammal is of the bovine or equine species.

21. A sperm dilution medium consisting of:
a base medium comprising components suited to diluting sperm of the determined species;
native phosphocaseinate;
egg yolk or egg yolk plasma; and
glycerol.

22. The sperm dilution medium of claim 21 which comprises from 0.5 to 5% by weight egg yolk dry matter or from 0.4 to 4% by weight of egg yolk plasma dry matter and from 1 to 10% glycerol.

23. The sperm dilution medium of claim 22 wherein the sperm dilution medium comprises from 1 to 2.5% egg yolk or from 0.8 to 2% by weight egg yolk plasma of dry matter and from 2 to 5% glycerol.

24. A method for preserving sperm by freezing which comprises the steps of:
diluting sperm in a sperm dilution medium comprising:
a base medium comprising components suited to diluting sperm of the determined species;
native phosphocaseinate;
egg yolk or egg yolk plasma; and
glycerol; and
freezing the diluted sperm.

25. The method of claim 24 wherein sperm is diluted on collection.
